(19) United States
(12) Patent Application Publication
(10) Pub. No.: US 2012/0322566 A1
(43) Pub. Date: Dec. 20, 2012

(54) REDUCER OF ELECTRIC POWER STEERING SYSTEM

(75) Inventor: Jong Han KIM, Incheon (KR)

(73) Assignee: Mando Corporation

(21) Appl. No.: 13/495,531

(22) Filed: Jun. 13, 2012

(30) Foreign Application Priority Data
Jun. 20, 2011 (KR) 10-2011-0059532

(51) Int. Cl. F16D 3/00

(52) U.S. Cl. 464/88

(57) ABSTRACT

The present invention relates to a reducer of an electric power steering system. By the system, it is possible to prevent a noise from being produced by a clearance between an inner rotor and an outer rotor. Further, since the steps of assembling the inner and outer rotors and applying grease are omitted, it is possible to simplify the assembling process of the reducer, to reduce the material costs, and to improve stability in assembling.

### CROSS-REFERENCE TO RELATED APPLICATION

This application claims priority from and the benefit under 35 U.S.C. §119(a) of Korean Patent Application No. 10-2011-0059532, filed on Jun. 20, 2011, which is hereby incorporated by reference for all purposes as if fully set forth herein.

### BACKGROUND OF THE INVENTION

1. Field of the invention

The present invention relates to a reducer of an electric power steering system. More particularly, the present invention relates to a reducer of an electric power steering apparatus, which, when compared with a conventional reducer of an electric power steering apparatus, makes it possible to prevent a noise from being produced by a clearance between an inner rotor and an outer rotor, and to reduce the material costs as well as to improve stability in assembling since the steps of assembling the inner rotor and outer rotor and applying grease are omitted.

2. Description of the Prior Art

As generally known in the art, a steering apparatus of a vehicle means an apparatus that allows a driver to change a driving direction of the vehicle by his/her will. The steering apparatus helps the driver to optionally change the center of rotation, about which the vehicle's front wheels are turned, so as to allow the vehicle to be driven in a direction desired by the driver. In such a steering apparatus, a power steering system is employed as an auxiliary power mechanism for reducing a driver's power required for steering. Such a power steering system may generally be classified into a hydraulic power steering system which utilizes a hydraulic force to support a steering force, in which the hydraulic force is produced by operating a hydraulic pump with a power of an engine, or an electric power steering system which employs an electric motor.

The hydraulic power steering system is configured to sense the rotation of a steering wheel, to operate the hydraulic pump by receiving a rotatory power from the engine, and to transmit the rotatory power to a driving part, such as a rack bar or a cylinder provided on a steering shaft, thereby supporting the driver's steering force.

The electric power steering system is configured to sense the rotation of a steering wheel, and to operate a motor provided on a rack or a steering shaft to support the rotational movement of the steering wheel, thereby allowing the steering apparatus to be smoothly operated. Such an electric power steering system is further classified into a rack driving type (R-EPS) or a steering shaft driving type (C-EPS).

FIG. 1 is a schematic view of a conventional electric power steering system.

As illustrated in FIG. 1, the electric power steering system includes a steering system 100 extending from a steering wheel 101 to a vehicle's wheels 108 which are opposed to each other, and an auxiliary power mechanism 120 configured to supply an auxiliary power to the steering system 100.

The steering system 100 includes a steering shaft 102, one side of which is connected to the steering wheel 101 to be rotated with the steering wheel 101, and the other side of which is connected to a pinion shaft 104 through a pair of universal joints 103. In addition, the pinion shaft 104 is connected to a rack bar through a rack-and-pinion mechanism 105, and the opposite ends of the rack bar are connected to the vehicle's wheels 108 through a pair of tie rods 106 and knuckle arms 107. The rack-and-pinion mechanism 105 is configured by a pinion gear 111 formed on the pinion shaft 104 and a rack gear 112 formed one side of the outer circumference of the rack bar, in which the pinion gear 111 and the rack gear 112 are adapted to be engaged with each other. A driver's manipulation of the steering wheel 101 produces torque, which in turn steers the vehicle's wheels 108 through the rack-and-pinion mechanism 105 and the tie rods 106.

The auxiliary power mechanism 120 includes: torque sensor 125 configured to sense torque applied to the steering wheel 101 by the driver and to output an electric signal in proportion to the sensed torque; an electronic control unit (ECU) 123 configured to produce a control signal based on the electric signal transmitted from the torque sensor 125; a motor 130 configured to produce an auxiliary power based on the signal transmitted from the ECU 123; and a reducer 140 configured to transmit the auxiliary power produced by the motor to the steering shaft 102.

FIG. 2 is a cross-sectional view illustrating a reducer of a conventional electric power steering system.

As illustrated in FIG. 2, the electric power steering system includes a motor 130, a driving shaft 205, an inner rotor 220, an outer rotor 215, an elastic member 210, a first bearing 250, a worm shaft 235, a worm gear 245, a second bearing 270, a compression screw 255, a compression spring 265, and a gear housing 260.

The motor 130 has a driving shaft 205 extending to the outside of a motor housing, and the outer rotor 215 is hollow and is connected to the driving shaft 215 at one side thereof to be cooperated with the driving shaft 215. The second bearing 270 and the first bearing 250 fix the worm gear 245 in relation to the worm wheel gear 240 fitted on the steering shaft. The compression spring 265 supports the worm gear 245 toward the worm wheel gear 240 through the compression spring 255, and supports the second bearing 270. Therefore, when tightened, the compression screw 255 is moved to contract the compression spring 265. Consequently, with the compression force of the compression spring 265, the worm gear 245 can be tightly engaged with the worm wheel gear 240.

The inner rotor 220 is connected to the worm shaft 235, in which the inner rotor 220 is configured to be introduced into the outer rotor 215, which is connected to the driving shaft 205 at one side thereof.

FIG. 3 is an exploded perspective view illustrating a part of a conventional reducer of an electric power steering system.

As illustrated in FIG. 3, the reducer of the electric power steering system includes: a damping coupler 360 constituted by the outer rotor 215, an elastic member 310 and the inner rotor 220; a boss 320 connected to one end of the driving shaft; and the worm shaft 235, in which the outer rotor 215 is configured to receive the inner rotor 220, and the elastic member 310 is interposed between the inner rotor 220 and the outer rotor 215. In addition, an axial serration-formed hole 345 is formed through the inner rotor 220 to be connected with the worm shaft 235 which is opposed to the hole 345 and formed with serrations 350. The outer rotor 215 provided with a serration-formed hole (not shown) is connected with the boss 320 which is formed with axial serrations 342 on the outer circumference thereof, and the boss 320, which is also formed with a serration-formed hole 340, is connected with the driving shaft 205 of the motor.

The reducer of the above-mentioned conventional electric power steering system has a construction in which the inner rotor and the outer rotor are coupled to each other merely by fitting the former into the latter by pressure, and the inner rotor and the inside of the outer rotor are configured to be abutted against each other. As a result, there is a problem in that when a vehicle loses the driving endurance thereof to a certain degree or when a large impact is reversely input through the steering shaft while the vehicle is being driven on a road, such as an unpaved road, a clearance between the inner and outer rotors is increased and a noise is produced due to the friction between the rotors.

In addition, there is a problem in that since the steps of assembling the inner and outer rotors and applying grease between the rotors are necessary, the number of assembling steps and the material costs are increased.

### SUMMARY OF THE INVENTION

Accordingly, the present invention has been made to solve the above-mentioned problems occurring in the prior art, and an object of the present invention is to prevent a noise from being produced by a clearance between an inner rotor and an outer rotor in a reducer of an electric power steering system, and to reduce the material costs as well as to improve stability in assembling by omitting the steps of assembling the inner and outer rotors and applying grease between the rotors.

In order to accomplish this object, there is provided a reducer of an electric power steering system including: a damping coupler, one side of which is connected with a worm shaft, and the other side of which is connected with a driving shaft of a motor, wherein the one side of the damping coupler is formed with a worm shaft coupling hole and the other side of the damping coupler is formed with a driving shaft coupling hole at the one side and the other side thereof in which one of the worm shaft coupling hole and the driving shaft coupling hole is formed with an axial recess and protrusion and the other is formed with a radial coupling recess, or each of the worm shaft coupling hole and the driving shaft coupling hole is formed with a radial coupling recess, and wherein in order to allow the worm shaft and the driving shaft to be correspondingly coupled to the worm shaft coupling hole and the driving shaft coupling hole, respectively, one of the worm shaft and the driving shaft is formed with a protrusion and recess corresponding to the axial recess and protrusion and the other of the worm shaft and the driving shaft is formed with a coupling protrusion corresponding to the radial coupling recess, or each of the worm shaft and the driving shaft is formed with a coupling protrusion corresponding to the radial coupling recess.

In accordance with the present invention, when compared with the prior art, it is possible to prevent a noise from being produced by a clearance between the inner rotor and the outer rotor, to simplify the assembling process of the reducer, and to reduce the material costs as well as to improve stability in assembling since the steps of assembling the inner and outer rotors, and applying grease are omitted.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view of a conventional electric power steering system;

FIG. 2 is a cross-sectional view illustrating a conventional reducer of an electric power steering system;

FIG. 3 is an exploded perspective view illustrating a part of the conventional reducer of an electric power steering system;

FIGS. 4 and 5 are exploded perspective views, which illustrate reducers of an electric power steering system in accordance with different exemplary embodiments of the present invention, respectively;

FIGS. 6a to 6c are front views, which illustrate reducers of an electric power steering system in accordance with various exemplary embodiments of the present invention, respectively; and

FIGS. 7 and 8 are graphs which illustrate a noise and a vibration quantity of a steering wheel, respectively.

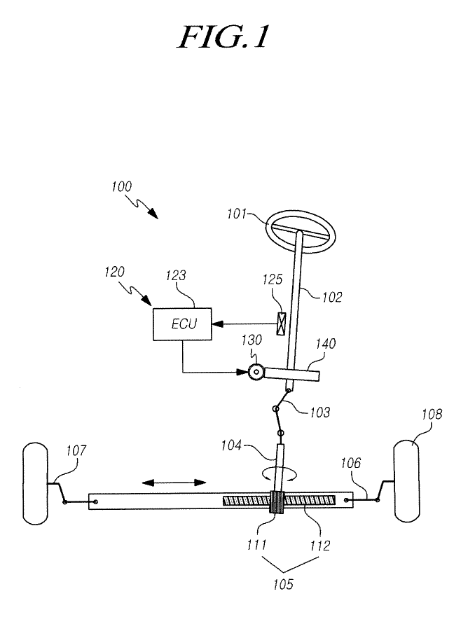

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

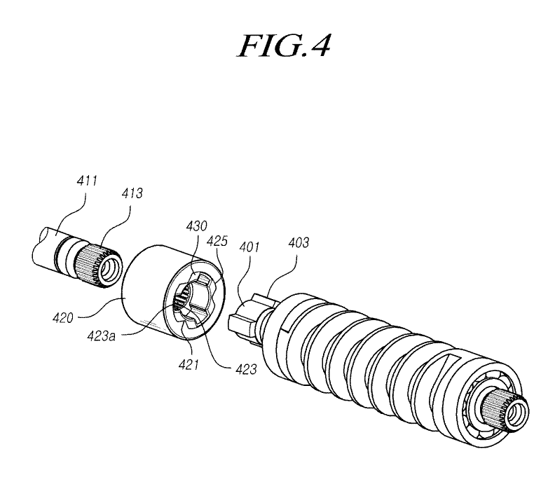

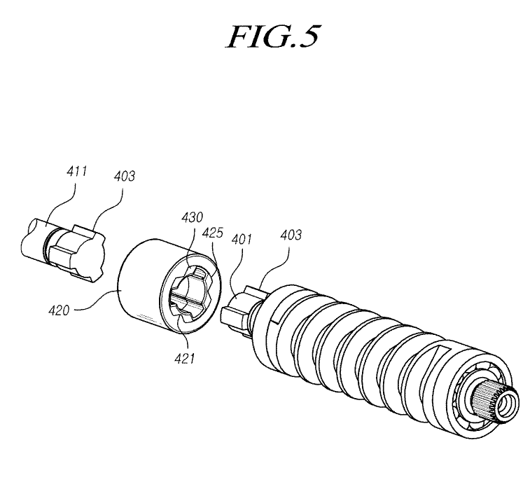

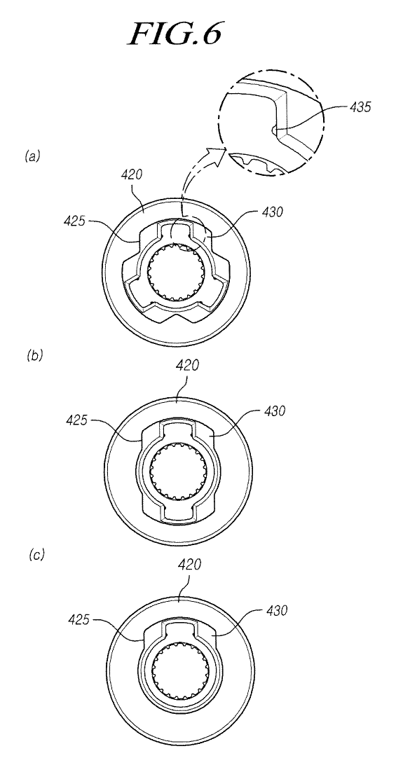

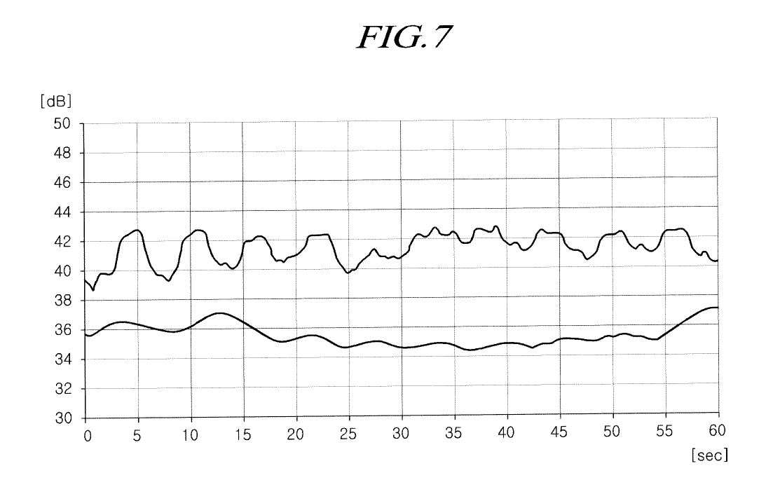

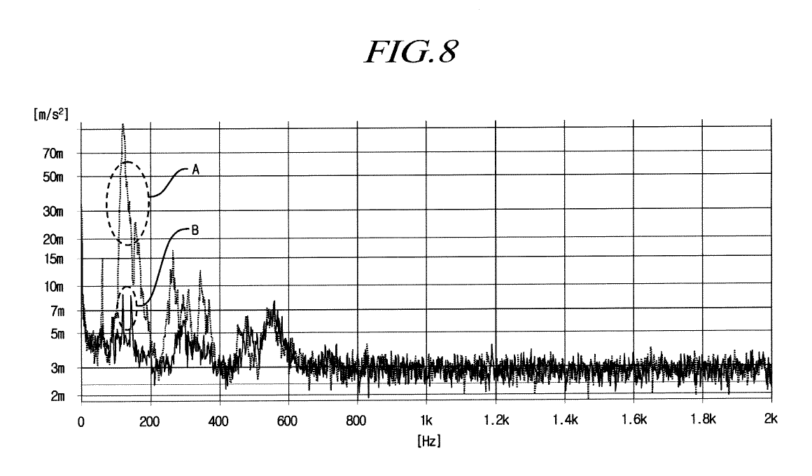

FIGS. 4 and 5 are exploded perspective views, which illustrate reducers of an electric power steering system in accordance with different exemplary embodiments of the present invention, respectively, FIGS. 6a to 6c are front views, which illustrate reducers of an electric power steering system in accordance with various exemplary embodiments of the present invention, respectively; and FIGS. 7 and 8 are graphs which illustrate a noise and a vibration quantity of a steering wheel, respectively.

As illustrated in these drawings, the inventive reducer of an electric power steering system includes: a damping coupler 420, one side of which is connected with a worm shaft 401, and the other side of which is connected with a driving shaft 411 of a motor, wherein the damping coupler 420 is formed with a worm shaft coupling hole 421 and a driving shaft coupling hole 423 at the one side and the other side thereof, respectively, in which one of the worm shaft coupling hole 421 and the driving shaft coupling hole 423 is formed with an axial recess and protrusion 423a and the other is formed with a radial coupling recess 425, or both of the worm shaft coupling hole 421 and the driving shaft coupling hole 423 are formed with a radial coupling recess 425, and wherein in order to allow the worm shaft 401 and the driving shaft 411 to be correspondingly coupled to the worm shaft coupling hole 421 and the driving shaft coupling hole 423, respectively, one of the worm shaft 401 and the driving shaft 411 is formed with a formed with a recess and protrusion 413 corresponding to the recess and protrusion 423a and the other is formed with a coupling protrusion 403 corresponding to the coupling recess 425, or both of the worm shaft 401 and the driving shaft 411 are formed with a coupling protrusion 403 corresponding to the coupling recess 425.

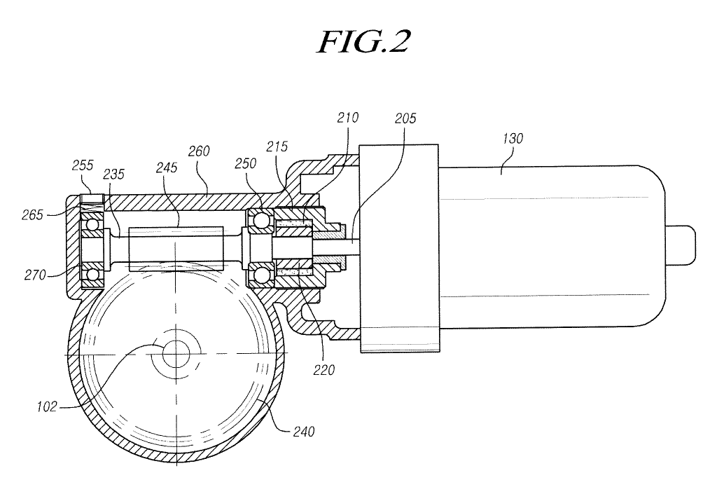

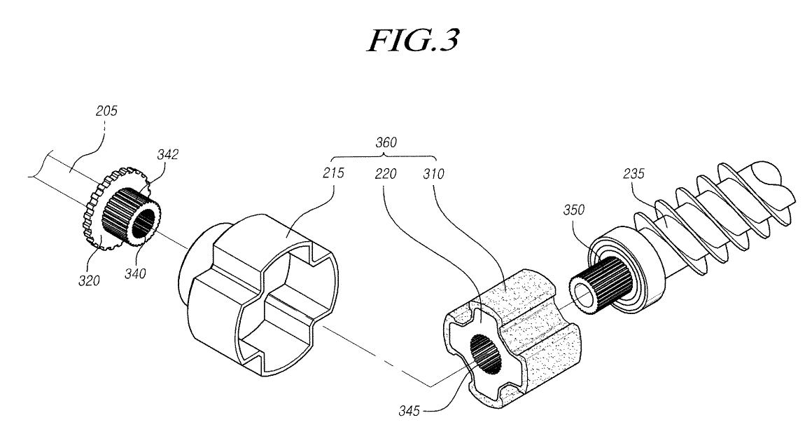

The damping coupler 420 is a power connection device configured to connect the driving shaft 411 of the motor for producing an auxiliary power of the electric power steering system and the worm shaft 401 to transmit the auxiliary power produced by the motor to a steering shaft coupled to a worm wheel (see the part indicated by reference numeral 240 in FIG. 2), thereby supporting the driver's steering force.

Such a damping coupler 420 is coaxially formed with a worm shaft coupling hole 421 coupled with the worm shaft 401, and a driving shaft coupling hole 423 coupled with the driving shaft 411 at the opposite sides thereof, respectively.

In addition, as illustrated in FIG. 4, one of the worm shaft coupling hole 421 and the driving shaft coupling hole 423 may be formed with an axial recess and protrusion 423a and the other is formed with a radial coupling recess 425, or as illustrated in FIG. 5, both of the worm shaft coupling hole 421 and the driving shaft coupling hole 423 may be formed with a radial coupling recess 425.

Furthermore, in order to allow the worm shaft 401 and the driving shaft 411 to be correspondingly coupled to the worm shaft coupling hole 421 and the driving shaft coupling hole 423, respectively, one of the worm shaft 401 and the driving shaft 411 is formed with a recess and protrusion 413 corresponding to the recess and protrusion 423a which are provided in the driving shaft coupling hole 423, and the other is formed with a coupling protrusion 403 corresponding to the coupling recess 425 which is provided in the driving shaft coupling hole 423, as illustrated in FIG. 4, or each of the worm shaft 401 and the driving shaft 411 is formed with a coupling protrusion 403 corresponding to the coupling recess 425, as illustrated in FIG. 5.

However, the present invention is not necessarily limited to these constructions. Since the coupling recess 425 and the coupling protrusions 403 are engaged with each other, it is possible to form a coupling recess (not shown) either on the outer circumference of the worm shaft 401 or on the driving shaft 411, and to form a coupling protrusion (not shown) corresponding to the coupling recess either in the worm shaft coupling hole 421 or in the driving shaft coupling hole 423, although not illustrated in the drawings.

A damping member 430 is interposed between the coupling recess 425 and the coupling protrusion 403, and is configured to conduct a damping effect for absorbing noise and vibration by being formed from natural rubber (NR), nitrile butadiene rubber (NBR), chloroprene rubber (CR), ethylene propylene diene terpolymer (EPDM), fluoro rubber (FPM), styrene butadiene rubber (SBR), chlorosulphonated polyethylene (CSM), urethane, silicone or the like to have weather resistance and elasticity.

The damping member 430 may be separately formed of any of the above-mentioned materials and coupled between the coupling recess 425 and the coupling protrusion 403. However, the damping member 430 may be integrally molded to the inner surface of the coupling recess 425 or integrally molded to the outer surface of the coupling protrusion 403.

When the damping member 430 is separately formed, it is coupled by inserting it into the coupling recess 425, and since the damping member 430 coupled to the coupling groove 425 has a predetermined fluidity, the misalignment between the driving shaft 411 and the worm shaft 401 can be compensated.

In addition, the damping member 430 is provided with a lug 435 on a part abutting against the coupling protrusion 403, and when the damping member 430 and the coupling protrusion 403 are coupled to each other, the lug 435 is tightly coupled while being compressed. Such a lug 435 is provided on each of inner opposite surfaces which are opposed to each other in the circumferential direction of the damping member 430.

When the damping member is coupled with the coupling protrusion 403, the compressed amount of the lug 435 is in the range of 0.25 to 0.45 mm when coupled with the coupling protrusion 403. If the compressed amount of the lug 435 is smaller than 0.25 mm, a noise may be increased over 40 dB, and the vibration quantity of the steering wheel may also be increased, and if the compressed amount is larger than 0.45 mm, the lug 435 is hardly coupled with the coupling protrusion 403, and the damping member 430 may be caused to be pushed away, which may also increase the noise and the vibration quantity of the steering wheel.

The noise of the reducer, to which the damping member 430 is coupled, and the vibration quantity of the steering wheel are illustrated in FIGS. 7 and 8, as compared with a conventional reducer. At first, in FIG. 7, the conventional reducer produces a sound generally higher than 40 dB that is a limit for making a driver recognize it as a noise, but the inventive reducer produces a sound lower than 36 dB. From this, the noise heard by the driver can be substantially reduced by the inventive reducer.

In addition, the vibration quantity of a steering wheel as shown in FIG. 8 was measured by installing an acceleration sensor on each of steering wheels. It can be found that in the section of 0 to 200 Hz, that is, in an initial stage of driving a reducer, the conventional reducer exhibits a vibration quantity (an acceleration of the steering wheel) that instantly exceeds 70 m/s² as in the “A” area which causes a serious deviation, but the inventive reducer exhibits a vibration quantity of 9 m/s² as in the “B” area which does not causes a serious deviation.

From this, it can be found that the vibration quantity of the steering wheel is definitely reduced in the initial section of driving the reducer, i.e., at a time point where an auxiliary force for steering is started to be produced.

Meanwhile, it may be possible to form two or more coupling recess 425 and two or more coupling protrusions 403 as illustrates in FIGS. 6a and 6b, or to form a single coupling recess 425 and a single coupling protrusion 403 as illustrated in FIG. 6c. When two or more coupling recesses and coupling protrusions are provided, they are formed to be equally spaced from each other in the circumferential direction.

Therefore, when the worm shaft 401 and the driving shaft 411 are rotated, the center of rotation and the center or gravity can be uniformly distributed.

In accordance with the present invention configured and shaped as described above, as compared with the prior art, it is possible to prevent a noise from being produced by a clearance between the inner and outer rotors, and it is also possible to simplify an assembling process, to reduce the material costs, and to improve stability in assembling since the steps of assembling the inner and outer rotors and applying grease between the inner and outer rotors.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. A reducer of an electric power steering system comprising:
a damping coupler, one side of which is connected with a worm shaft, and the other side of which is connected with a driving shaft of a motor,
wherein the one side of the damping coupler is formed with a worm shaft coupling hole and the other side of the damping coupler is formed with a driving shaft coupling hole at the one side and the other side thereof in which one of the worm shaft coupling hole and the driving shaft coupling hole is formed with an axial recess and protrusion and the other is formed with a radial coupling recess, or each of the worm shaft coupling hole and the driving shaft coupling hole is formed with a radial coupling recess, and
wherein in order to allow the worm shaft and the driving shaft to be correspondingly coupled to the worm shaft coupling hole and the driving shaft coupling hole, respectively, one of the worm shaft and the driving shaft is formed with a protrusion and recess corresponding to the axial recess and protrusion and the other of the worm shaft and the driving shaft is formed with a coupling protrusion corresponding to the radial coupling recess, or each of the worm shaft and the driving shaft is formed with a coupling protrusion corresponding to the radial coupling recess.

2. The reducer as claimed in claim 1, further comprising a damping member coupled between the coupling recess and the coupling protrusion.

3. The reducer as claimed in claim 2, wherein the damping member is integrally molded with the coupling recess.

4. The reducer as claimed in claim 2, wherein the damping member is provided with a lug at a part where the damping member abuts against the coupling protrusion, so that the damping member is coupled with the coupling protrusion to be in close contact as the lug is compressed when the damping member is coupled with the coupling protrusion.

5. The reducer as claimed in claim 4, wherein the lug is provided on each of the inner lateral surfaces which are opposed to each other in the circumferential direction of the damping member.

6. The reducer as claimed in claim 5, wherein the compressed quantity of the lug is in the range of 0.25 to 0.45 mm.

7. The reducer as claimed in claim 2, wherein two or more coupling recesses and two or more coupling protrusions are provided.

8. The reducer as claimed in claim 7, wherein either the coupling recesses or the coupling protrusions are equally spaced from each other in the circumferential direction.
